(19) United States
(12) Patent Application Publication
(10) Pub. No.: US 2026/0188563 A1
(43) Pub. Date: Jul. 2, 2026

(54) COIL COMPONENT

(71) Applicant: SAMSUNG ELECTRO-MECHANICS CO., LTD., Suwon-si (KR)

(72) Inventors: Dong Gun LEE, Suwon-si (KR); Dong Hwi AHN, Suwon-si (KR)

(73) Assignee: SAMSUNG ELECTRO-MECHANICS CO., LTD., Suwon-si (KR)

(21) Appl. No.: 19/382,682

(22) Filed: Nov. 7, 2025

(30) Foreign Application Priority Data
Dec. 31, 2024 (KR) 10-2024-0201604

(51) Int. Cl. H01F 27/29; H01F 27/08

(52) U.S. Cl. CPC H01F 27/29; H01F 27/08

(57) ABSTRACT

A coil component includes a body including a first surface and a second surface, facing each other in a first direction, and a third surface and a fourth surface, facing each other in a second direction, perpendicular to the first direction; a coil disposed in the body; and an external electrode disposed in the body and connected to the coil, the external electrode may include a base portion disposed on the first surface or the second surface, an insertion portion bent from the base portion and at least a portion of which is disposed in the body, and an extension portion bent from the base portion and respectively extending to the third surface and the fourth surface.

### CROSS-REFERENCE TO RELATED APPLICATION(S)

This application claims benefit of priority to Korean Patent Application No. 10-2024-0201604 filed on Dec. 31, 2024 in the Korean Intellectual Property Office, the disclosure of which is incorporated herein by reference in its entirety.

### TECHNICAL FIELD

The present disclosure relates to a coil component.

An inductor, a coil component, is a representative passive electronic component used in electronic devices, along with resistors and capacitors. The coil component may control a flow of current through a coil, remove noise, and protect an electronic device by preventing rapid changes in current therein.

As electronic devices are increasingly implemented with high-performance and are miniaturized, the number of inductors used in electronic devices is also increasing and are miniaturized.

Meanwhile, as the number of electronic devices used in a vehicle increases, especially the number of electronic devices directly mounted in an engine bay increases, there is a demand for an inductor having improved vibration resistance and improved heat dissipation effect.

### SUMMARY

An aspect of the present disclosure is to provide a coil component having improved vibration resistance when mounted on a circuit board by strengthening bonding force between a body and an external electrode.

Another aspect of the present disclosure is to provide a coil component having improved heat dissipation by increasing an exposed area of an external electrode.

According to an aspect of the present disclosure, a coil component may be provided, the coil component including: a body including a first surface and a second surface, facing each other in a first direction, and a third surface and a fourth surface, facing each other in a second direction, perpendicular to the first direction, a coil disposed in the body, and an external electrode disposed in the body and connected to the coil, wherein the external electrode includes a base portion disposed on the first surface or the second surface, an insertion portion bent from the base portion and at least a portion of which is disposed in the body, and an extension portion bent from the base portion and respectively extending to the third surface and the fourth surface.

According to another aspect of the present disclosure, a coil component may be provided, the coil component including: a body including a first surface and a second surface, facing each other in a first direction, a third surface and a fourth surface, facing each other in a second direction, and a fifth surface and a sixth surface, facing each other in a third direction, a coil disposed in the body, first and second external electrodes disposed in the body and connected to the coil, and facing each other in a first direction, wherein each of the first and second external electrodes includes an insertion portion, at least a portion of which is disposed in the body, an extension portion extending to both sides thereof in the second direction and respectively being bent in the first direction, and a pad portion extending to the fifth surface, and respective ends of the extension portion is disposed to face each other in a second direction, and the insertion portion and the pad portion are disposed to face each other in a third direction.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective view schematically illustrating a coil component according to a first embodiment of the present disclosure;

FIG. 2 is a perspective view illustrating the internal configuration of FIG. 1;

FIG. 3 is a diagram illustrating a cross-section taken along line I-I′ of FIG. 1;

FIG. 4 is a side view of FIG. 1 as viewed from a first direction;

FIG. 5 is a side view of FIG. 1 as viewed from a second direction;

FIG. 6 is a diagram illustrating a state before bending an external electrode;

FIG. 7 is a graph illustrating a standard value of equivalent stress according to a change in a minimum distance (T1) between an uppermost extension line of an insertion portion and an uppermost end of an extension portion;

FIG. 8 is a perspective view schematically illustrating a coil component according to a second embodiment of the present disclosure;

FIG. 9 is a perspective view schematically illustrating a coil component according to a modified example of the second embodiment of the present disclosure;

FIG. 10 is a perspective view schematically illustrating a coil component according to a third embodiment of the present disclosure;

FIG. 11 is a perspective view schematically illustrating a coil component according to a fourth embodiment of the present disclosure;

FIG. 12 is a diagram illustrating a form in which the coil component of FIG. 1 is mounted on a circuit board through a pad portion;

FIG. 13 is a diagram illustrating a form in which the coil component of FIG. 1 is mounted on a circuit board through an extension portion;

FIG. 14 is a perspective view schematically illustrating a coil component according to a fifth embodiment of the present disclosure;

FIG. 15 is a perspective view schematically illustrating a coil component according to a sixth embodiment of the present disclosure; and

FIG. 16 is a perspective view schematically illustrating a coil component according to a seventh embodiment of the present disclosure.

### DETAILED DESCRIPTION

The terms used in the present application are only used to describe specific embodiments, and are not intended to limit the present disclosure. The singular expression includes the plural expression unless the context clearly dictates otherwise. In the present application, terms such as “comprise” or “have” are intended to designate that a feature, number, operation, operation, component, part, or combination thereof described in the specification exists, and it should be understood that this does not preclude the possibility of addition or existence of one or more other features or numbers, operations, operations, components, parts, or combinations thereof. Throughout the specification, “on” means to be positioned above or below the target part, and does not necessarily mean to be positioned on the upper side with respect to the direction of gravity.

In addition, the term “coupling” does not mean only a case of direct physical contact between respective components in the contact relationship between respective components, and is used as a concept that encompasses even the case in which other components are interposed between respective components and the components are respectively in contact with the other components.

The size and thickness of each component illustrated in the drawings are arbitrarily indicated for convenience of description, and thus, the present disclosure is not necessarily limited to the illustration.

In the drawings, an L-direction may be defined as a first direction or a length direction, a W-direction may be defined as a second direction or a width direction, and a T-direction may be defined as a third direction or a thickness direction.

Hereinafter, a coil component according to an embodiment will be described in detail with reference to the accompanying drawings, and in describing the coil component with reference to the accompanying drawings, the same or corresponding components are given the same reference numerals, and the overlapping description thereof will be omitted.

Various types of electronic components are used in electronic devices, and among these electronic components, various types of coil components may be appropriately used for noise removal, or the like.

For example, in electronic devices, the coil component may be used as a power inductor, a high frequency (HF) inductor, a general bead, a high frequency bead (GHz Bead), a common mode filter, or the like.

### First Embodiment

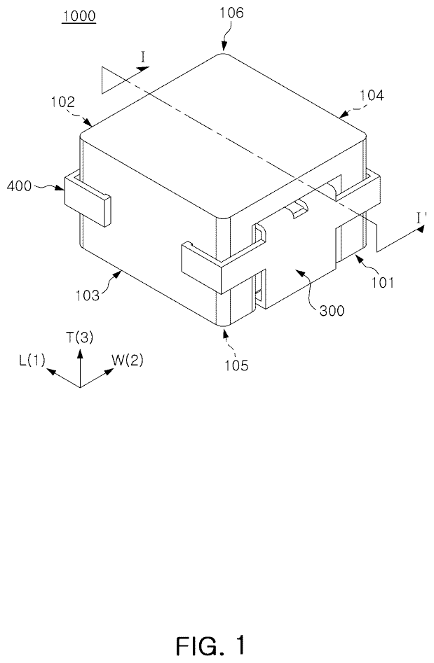

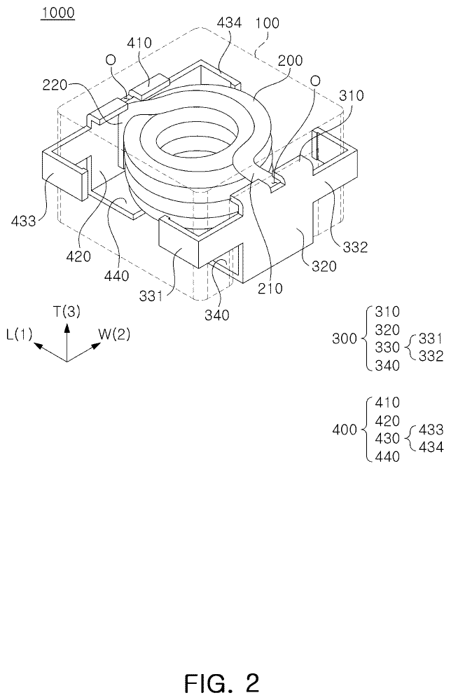

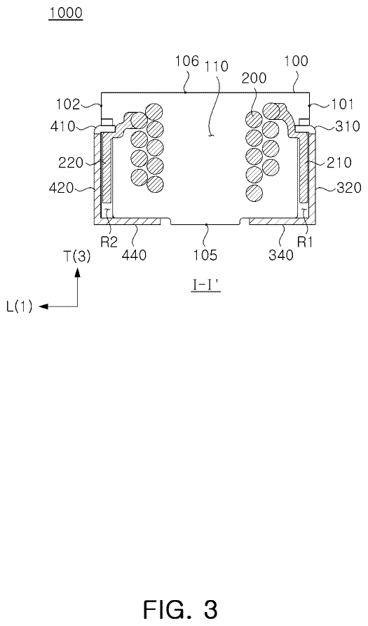

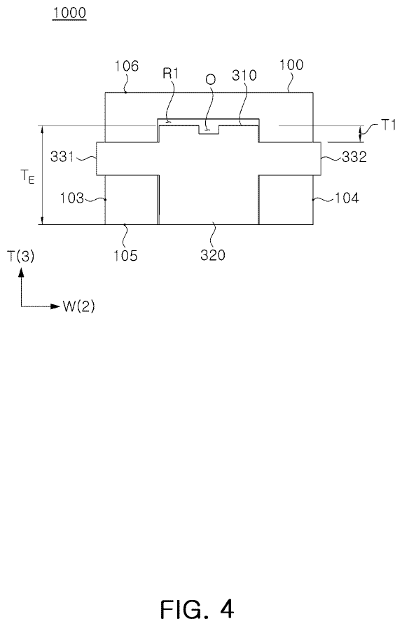

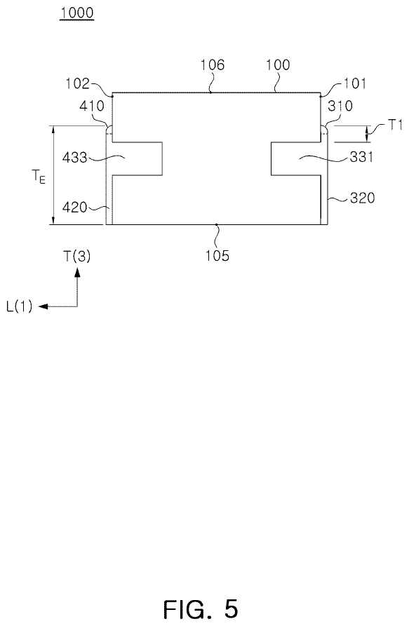

FIG. 1 is a perspective view schematically illustrating a coil component 1000 according to a first embodiment of the present disclosure. FIG. 2 is a perspective view illustrating the internal configuration of FIG. 1. FIG. 3 is a diagram illustrating a cross-section taken along line I-I′ of FIG. 1. FIG. 4 is a side view of FIG. 1 as viewed from a first direction. FIG. 5 is a side view of FIG. 1 as viewed from a second direction.

Referring to FIGS. 1 to 5, a coil component 1000 according to a first embodiment of the present disclosure may include a body 100, a coil 200, and external electrodes 300 and 400. In addition, the external electrodes 300 and 400 may include insertion portions 310 and 410, base portions 320 and 420, and extension portions 330 and 340, and further include pad portions 340 and 440.

In the coil component 1000 according to the present disclosure, the external electrodes 300 and 400 may include extension portions 330 and 340 extending to both sides in the second direction (W-direction), and the extension portions 330 and 440, at least a portion of the extension portions 330 and 440 may be bent in the first direction (X-direction) and disposed to extend to the third surface 103 and the fourth surface 104, so that stress acting on the coil component 1000 when mounting the coil component 1000 on a circuit board may be reduced, and accordingly, vibration resistance of the coil component 1000 against vibrations in the second direction (W-direction) may be reinforced.

Meanwhile, the stress reduction effect may vary depending on a ratio (T1/T_{E}) of a minimum distance (T1) between an uppermost extension line of the insertion portions 310 and 410 and an uppermost end of the extension portions 330 and 430, relative to a maximum length (T_{E}) of the external electrodes 300 and 400 in the third direction (T-direction), which will be described later with reference to FIG. 4.

Hereinafter, the main components constituting the coil component 1000 according to the present embodiment will be described in detail.

The body 100 forms the exterior of the coil component 1000 according to the present embodiment, and the coil 200 is buried therein.

The body 100 may be formed to have an overall hexahedral shape.

The body 100 includes a first surface 101 and a second surface 102, facing each other in a first direction (L-direction), a third surface 103 and a fourth surface 104, facing each other in a second direction (W-direction), and a fifth surface 105 and a sixth surface 106, facing each other in a third direction (T-direction). Each of the first surface 101, the second surface 102, the third surface 103, and the fourth surface 104 may correspond to a wall surface of the body 100 connecting the fifth surface 105 and the sixth surface 106 of the body 100.

In the body 100, as an example, the coil component 1000 including the external electrodes 300 and 400 according to the present embodiment may be formed to have a length of 4.0 mm, a width of 4.0 mm, and a thickness of 2.0 mm, to have a length of 4.0 mm, a width of 4.0 mm, and a thickness of 1.5 mm, to have a length of 4.0 mm, a width of 4.0 mm, and a thickness of 1.2 mm, to have a length of 3.2 mm, a width of 2.5 mm, and a thickness of 1.2 mm, to have a length of 2.5 mm, a width of 2.0 mm, and a thickness of 1.2 mm, or to have a length of 2.0 mm, a width of 1.6 mm, and a thickness of 1.2 mm, but the present disclosure is not limited thereto. Meanwhile, the above-described exemplary values for the length, width, and thickness of the coil component 1000 refer to values that do not reflect process errors, and the values within the range that may be recognized as process errors should be considered to correspond to the above-described exemplary values.

Based on an optical microscope image or a scanning electron microscope (SEM) image of a cross-section in a length direction (L)-thickness direction (T) taken from a central portion of the coil component 1000 in a width direction (W), the length of the coil component 1000 described above may refer to a maximum value of dimensions of each of a plurality of line segments, which are provided by connecting two outermost boundary lines of the coil component 1000, facing each other in the length direction (L) of the coil component 1000, illustrated in the cross-sectional image, to be parallel to the length direction (L), and being spaced apart from each other in the thickness direction (T). Alternatively, the length of the coil component 1000 may refer to a minimum value of the dimensions of each of the plurality of line segments described above. Alternatively, the length of the coil component 1000 may refer to an arithmetic mean value of at least three or more of the dimensions of the dimensions of each of the plurality of line segments described above. In this case, the plurality of line segments, parallel to the length direction (L) may be equally spaced from each other in the thickness direction (T), but the scope of the present disclosure is not limited thereto.

Based on an optical microscope image or a scanning electron microscope (SEM) image of a cross-section in a length direction (L)-thickness direction (T) taken from a central portion of the coil component 1000 in a width direction (W), the thickness of the coil component 1000 described above may refer to a maximum value of dimensions of each of a plurality of line segments, which are provided by connecting two outermost boundary lines of the coil component 1000, facing each other in the thickness direction (T) of the coil component 1000, illustrated in the cross-sectional image, to be parallel to the thickness direction (T), and being spaced apart from each other in the length direction (L). Alternatively, the thickness of the coil component 1000 may refer to a minimum value of the dimensions of each of the plurality of line segments described above. Alternatively, the thickness of the coil component 1000 may refer to an arithmetic mean value of at least three or more of the dimensions of each of the plurality of line segments described above. In this case, the plurality of line segments, parallel to the thickness direction (T) may be equally spaced from each other in the length direction (L), but the scope of the present disclosure is not limited thereto.

Based on an optical microscope image or a scanning electron microscope (SEM) image of a cross-section in a length direction (L)-thickness direction (T) taken from a central portion of the coil component 1000 in a thickness direction (T), the width of the coil component 1000 described above may refer to a maximum value of dimensions of each of a plurality of line segments, which are provided by connecting two outermost boundary lines of the coil component 1000, facing each other in the width direction (W) of the coil component 1000, illustrated in the cross-sectional image, to be parallel to the width direction (W), and being spaced apart from each other in the length direction (L). Alternatively, the width of the coil component 1000 may refer to a minimum value of the dimensions of each of the plurality of line segments described above. Alternatively, the width of the coil component 1000 may refer to an arithmetic mean value of at least three or more of the dimensions of each of the plurality of line segments described above. In this case, the plurality of line segments, parallel to the width direction (W) may be equally spaced from each other in the length direction (L), but the scope of the present disclosure is not limited thereto.

Alternatively, each of the length, width, and thickness of the coil component 1000 may be measured by a micrometer measurement method. The micrometer measurement method may be performed by setting the zero point with a gage Repeatability and Reproducibility (R&R) micrometer, inserting the coil component 1000 according to this embodiment between the tips of the micrometer and turning the measuring lever of the micrometer. On the other hand, in measuring the length of the coil component 1000 by the micrometer measurement method, the length of the coil component 1000 may refer to a value measured once, and may also refer to an arithmetic mean of values measured multiple times. This may equally be applied to the width and thickness of the coil component 1000.

The body 100 may include a magnetic material and a resin. The body 100 may be formed by filling a mold with a composite material including a magnetic material and a resin. A molding process of applying high temperature and high pressure to the magnetic material or the composite material in the mold may be additionally performed, but an embodiment thereof is not limited thereto.

The body 100 may be formed to have two regions, upper and lower regions, centered on a coil 200, for example, and may be combined with each other to form one body 100. In this case, the upper and lower regions of the body 100 may have different densities depending on a formation temperature or pressure thereof, and the components included in each of the upper and lower regions thereof may also be partially different, but an embodiment thereof is not limited thereto.

The magnetic material included in the body 100 may be, for example, ferrite or magnetic powder.

Ferrite may be at least one of, for example, spinel-type ferrites such as Mg—Zn, Mn—Zn, Mn—Mg, Cu—Zn, Mg—Mn—Sr, Ni—Zn, and the like, hexagonal ferrites such as Ba—Zn, Ba—Mg, Ba—Ni, Ba—Co, and Ba—Ni—Co, and the like, garnet-type ferrites such as Y and the like, and Li ferrites.

The magnetic metal powder may include at least one selected from the group consisting of iron (Fe), silicon (Si), chromium (Cr), cobalt (Co), molybdenum (Mo), aluminum (Al), niobium (Nb), copper (Cu), boron (B), zirconium (Zr), hafnium (Hf), phosphorus (P), and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr alloy powder, and Fe—Cr—Al alloy powder.

The magnetic metal powder may include amorphous and/or crystalline. For example, the magnetic metal powder may be an Fe—Si—B—Cr-based amorphous alloy powder, but the present disclosure is not limited thereto.

Each of ferrite and magnetic metal powder may have an average diameter of about 0.1 μm to 30 μm, but the present disclosure is not limited thereto.

The body 100 may include two or more types of magnetic materials dispersed in a resin. In this case, the different types of magnetic materials mean that the magnetic materials dispersed in the resin are distinguished from each other by any one of an average diameter, composition, crystallinity, and shape.

The resin may include, but is not limited to, epoxy, polyimide, a liquid crystal polymer, or the like, alone or in combination thereof.

Referring to FIGS. 2 and 3, the body 100 include a core 110. The core 110 may mean a region of the body 100 charged to penetrate through an air core of the coil 200. The core 110 may be disposed in an inner region of the coil 200 forming at least one turn, and a cross-section of the core 110 may be circular or elliptical in a cross-section perpendicular to a winding axis of the coil 200, but the present disclosure is not limited thereto, and when the coil 200 has a square shape, the cross-section of the core 110 may also have a square shape.

Referring to FIG. 3, recesses R1 and R2 may be formed in at least one of a region between the first surface 101 and the fifth surface 105 of the body 100 and a region between the second surface 102 and the fifth surface 105. In an embodiment, a first recess R1 formed on the first surface 101 may extend to a fifth surface 105, and a second recess R2 formed on the second surface 102 may extend to a fifth surface 106.

The recesses R1 and R2 may correspond to a region in which a step is formed inside of the body 100 to accommodate lead-out portions 210 and 220 and external electrodes 300 and 400, and by disposing the lead-out portions 210 and 220 of the coil 200, insertion portions 310 and 410, base portions 320 and 420, and pad portions 340 and 440 of the external electrodes 300 and 400 in the recesses R1 and R2, the size of the coil component 1000 may be implemented to be small.

Meanwhile, for convenience of explanation, the region in which the recesses R1 and R2 are formed is also defined as being included in the first surface 101, the second surface 102, and the fifth surface 105 of the body 100.

An insertion portion 310, a base portion 320, and a pad portion 340 of a first external electrode 300 may be disposed on the first recess R1, and an insertion portion 410, a base portion 420, and a pad portion 440 of a second external electrode 400 may be disposed on the second recess R2. However, an embodiment thereof is not limited thereto, and in an embodiment, the lead-out portions 210 and 220 and the external electrodes 300 and 400 may also be disposed in a protruding form on a flat surface of the body 100 without recesses R1 and R2.

The coil 200 is disposed in the body 100, and is configured to express the characteristics of the coil component 1000. For example, when the coil component 1000 of the present embodiment is utilized as a power inductor, the coil 200 may function to stabilize power of an electronic device by storing an electric field as a magnetic field and maintaining an output voltage.

Referring to FIGS. 2 and 3, the coil 200 forms at least one turn centered on the core 110, and may include lead-out portions 210 and 220 at both ends of the outermost turn. Specifically, the coil 200 may include a first lead-out portion 210, drawn out to a first surface 101 of the body 100, and a second lead-out portion 220, drawn out to a second surface 102 of the body 100.

The first lead-out portion 210 may be disposed between the body 100 and the first external electrode 300, and the second lead-out portion 220 may be disposed between the body 100 and the second external electrode 400. The first lead-out portion 210 may extend along a surface of the first recess R1 formed on the first surface 101 of the body 100, and the second lead-out portion 220 may extend along a surface of the second recess R2 formed on the second surface 102 of the body 100. However, an embodiment thereof is not limited thereto, and each of the first lead-out portion 210 and the second lead-out portion 220 may extend along the surface of the first recess R1 and the second recess R2, which are formed to be spaced apart from each other on the fifth surface 105.

Referring to FIGS. 2 and 3, the lead-out portions 210 and 220 may be formed by rolling both ends of the coil 200, and may have a flat shape by rolling. That is, a thickness of the lead-out portions 210 and 220 may be formed thinner than a diameter of the coil 200, and a width of a surface of the lead-out portions 210 and 220 in contact with the external electrodes 300 and 400 may be formed wider than the diameter of the coil 200.

In an embodiment, when a surface bonding structure between the lead-out portions 210 and 220 and the external electrodes 300 and 400 is provided, as described above, a contact area may be widened, so that bonding reliability between the lead-out portions 210 and 220 and the external electrodes 300 and 400 may be improved, and Rdc characteristics may also be improved.

The coil 200 of the present embodiment may correspond to an air core coil, and may be a wound coil, but an embodiment thereof is not limited thereto. The coil 200 may be coated with an insulating material in the remaining region except for the lead-out portions 210 and 220, connected to the external electrodes 300 and 400. Accordingly, a surface of each turn of the coil 200 may be coated with an insulating material so that insulation may be maintained even after winding.

Specifically, the coil 200 may be formed by winding a metal wire of which a surface is coated with an insulating material in a spiral shape. The metal wire may be a copper wire, but an embodiment thereof is not limited thereto.

Meanwhile, the coil component 1000 according to the present embodiment exemplifies a case in which the coil 200 is formed as a circular conductor, but an embodiment thereof is not limited thereto, and when the coil 200 is formed using a flat metal wire, a cross-section of each turn of the coil 200 may be a square shape.

The coil 200 of the present embodiment may include a conductive material such as copper (Cu), aluminum (Al), silver (Ag), tin (Sn), gold (Au), nickel (Ni), lead (Pb), titanium (Ti), chromium (Cr), molybdenum (Mo), or an alloy thereof, but an embodiment thereof is not limited thereto.

Referring to FIGS. 1 to 5, a coil component 1000 according to the present embodiment may include external electrodes 300 and 400 disposed on a body 100 and connected to a coil 200.

When the coil component 1000 according to the present embodiment is mounted on a circuit board, or the like, the external electrodes 300 and 400 are configured to electrically connect the coil component 1000 and circuit board. For example, a pad portion 340 of the first external electrode 300 and a pad portion 440 of the second external electrode 400, disposed to be spaced apart from each other on the fifth surface 105 of the body 100, may be electrically connected to a connection portion of the circuit board.

Referring to FIGS. 2 and 3, a first external electrode 300 may be disposed on the first surface 101 of the body 100, and may be connected in contact with the first lead-out portion 210, drawn out to the first surface 101 of the body 100, and a second external electrode 400 may be disposed on the second surface 102 of the body 100, and may be connected in contact with the second lead-out portion 220, extended to the second surface 102 of the body 100.

The external electrodes 300 and 400 of an embodiment may include base portions 320 and 430 disposed on the first surface 101 or the second surface 102 of the body 100, insertion portions 310 and 410 bent from the base portions 320 and 420 and at least a portion of which is disposed in the body 100, and extension portions 330 and 430 bent from the base portions 320 and 420 and respectively extended to the third surface 103 and the fourth surface 104 of the body 100. In addition, the external electrodes 300 and 400 of an embodiment may further include pad portions 340 and 440 extending from the base portions 320 and 420 to the fifth surface 105 of the body 100.

Here, the insertion portions 310 and 410, the base portions 320 and 420, the extension portions 330 and 430, and the pad portion 340 and 440 may be formed integrally, which is only defined by dividing regions of the external electrodes 300 and 400 for convenience of explanation.

Referring to FIGS. 2 to 4, the insertion portions 310 and 410 may have one end disposed in the body 100 and the other end bent to be connected to the base portions 320 and 420. In addition, the insertion portions 310 and 410 may be in contact with the lead-out portions 210 and 220. At least a portion of the lead-out portions 210 and 220 may be exposed to the outside through an opening (O).

The insertion portions 310 and 410 may have the function of fixing the external electrodes 300 and 400 to the body 100, and may be disposed to face the pad portions 340 and 440 in a third direction (T-direction), so that the coil component 100 according to the present embodiment may have improved vibration resistance against vibrations in the third direction (T-direction).

In an embodiment, the other end of the insertion portions 310 and 410, i.e., at least a portion of a region in which the insertion portions 310 and 410 are bent and in contact with the base portions 320 and 420, may include an opening (O).

The opening (O) is a region penetrating through the external electrodes 300 and 400, and may reduce a load when performing a process of bending the external electrodes 300 and 400, thereby preventing damage to the external electrodes 300 and 400. Meanwhile, when the external electrodes 300 and 400 have sufficient rigidity to withstand the load generated during the bending process, the opening (O) of the present embodiment may be omitted.

Referring to FIGS. 2 and 3, the base portions 320 and 420 of the external electrodes 300 and 400 are configured to extend from the other end of the insertion portions 310 and 410 and disposed on a first surface 101 or a second surface 120. Specifically, the base portion 320 of the first external electrode 300 may be disposed on the first surface 101 and connected to the first lead-out portion 210, and the base portion 420 of the second external electrode 400 may be disposed on the second surface 102 and connected to the second lead-out portion 220.

Meanwhile, the lead-out portions 210 and 220 may be covered with a metal layer (not shown) while being disposed on the base portions 320 and 420. The metal layer may include at least one of nickel (Ni), tin (Sn), and copper (Cu), and may be comprised of multiple layers. The metal layer may be formed through processes such as dipping and soldering, but an embodiment thereof is not limited thereto. When the lead-out portions 210 and 220 are covered with a metal layer and fixed to the base portions 320 and 420, bonding force between the lead-out portions 210 and 220 and the base portions 320 and 420 may be strengthened.

Referring to FIGS. 2, 4, and 5, the external electrodes 300 and 400 of the coil component 1000 according to the present embodiment may include extension portions 330 and 430 respectively extending from the base portions 320 and 420 to both sides thereof in a second direction (W-direction).

The extension portions 330 and 430 is configured to be respectively extended to both sides in the second direction (W-direction) and bent in the first direction (L-direction) to be disposed on the third surface 103 and the fourth surface 104, so that bonding force between the body 100 and the external electrodes 300 and 400 may be strengthened, and stress acting on the coil component 1000 when mounting the coil component 1000 on a circuit board may be relieved.

Specifically, the first external electrode 300 may include a first extension portion 331, at least a portion of which extends from the base portion 320 to the third surface 103, and a second extension portion 332, at least a portion of which extends to the fourth surface 104. In addition, the second external electrode 400 may include a third extension portion 433, at least a portion of which extends from the base portion 420 to the third surface 103, and a fourth extension portion 434, at least a portion of which extends to the fourth surface 104.

The first extension portion 331 and the second extension portion 332 may be disposed to face each other in a second direction (W-direction), and the third extension portion 433 and the fourth extension portion 434 may also be disposed to face each other in the second direction (W-direction). The coil component 1000 according to the present embodiment may have improved vibration resistance against vibrations in the second direction (W-direction), which may be vulnerable in the case of a general electrode shape without an extension portion, through the above-described structure.

Referring to FIGS. 2 and 4, the external electrodes 300 and 400 may further include pad portions 340 and 440 extending from the base portions 320 and 420 to the fifth surface 105 of the body 100. The pad portions 340 and 440 are configured to be bent from the base portions 320 and 420 and extend to the fifth surface 105 of the body 100. The pad portions 340 and 440 may be bent and extended in the first direction (L-direction) and disposed on recesses R1 and R2 formed on the fifth surface 105 of the body 100. However, an embodiment thereof is not limited thereto, and when the fifth surface 105 of the body 100 is a flat surface without the recesses R1 and R2, the pad portions 340 and 440 may be disposed directly on the fifth surface 105.

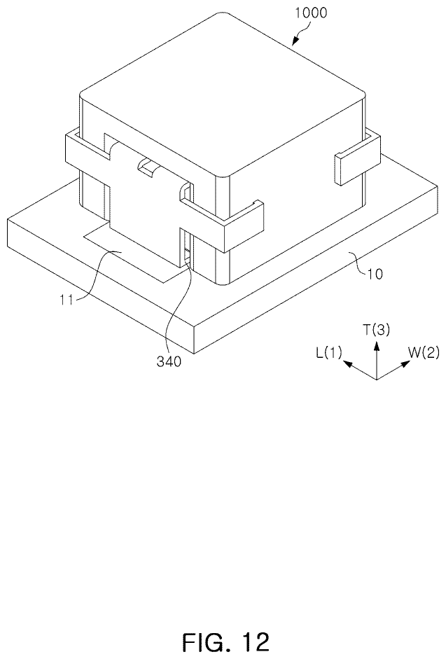

FIG. 12 is a diagram illustrating a form in which the coil component of FIG. 1 is mounted on a circuit board through a pad portion.

Referring to FIGS. 2, 3, and 12, when mounting the coil component 1000 according to the present embodiment to a printed circuit board, the pad portions 340 and 440 are configured to be connected to a connection portion of the circuit board, and for example, a bonding member such as solder, or the like is disposed between the pad portions 340 and 440 and the connection portion of the circuit board, so that the coil component 1000 and the circuit may be electrically connected.

Referring to FIGS. 1 and 2, the first external electrode 300 of the present embodiment may include an insertion portion 310 and a base portion 320 disposed on the first surface 101 of the body 100, a first extension portion 331 disposed across the first surface 101 and the third surface 103, a second extension portion 332 disposed across the first surface 101 and the fourth surface 104, and a pad portion 340 disposed on the fifth surface 105.

In addition, the second external electrode 400 of the present embodiment may include an insertion portion 410 and a base portion 420 disposed on the second surface 102 of the body 100, a third extension portion 433 disposed across the second surface 102 and the third surface 103, a fourth extension portion 434 disposed across the second surface 102 and the third surface 103, and a pad portion 440 disposed on the fifth surface 105.

Accordingly, the external electrodes 300 and 400 of the present embodiment may be disposed on the first surface 101 to the fifth surface 105 of the body 100, and may be spaced apart from the sixth surface 106. Meanwhile, when the coil component 1000 of the present embodiment is mounted on a circuit board, stress acting on the coil component 1000 in the first direction (L-direction) may be relieved by the base portions 320 and 420, facing each other in the first direction (L-direction), stress acting on the coil component 1000 in the second direction (W-direction) may be relieved by respective ends of the extension portions 331, 332, 433, and 434, facing each other in the second direction (W-direction), and stress acting on the coil component 1000 in the third direction (T direction) may be relieved by the insertion portions 310 and 410 and pad portions 340 and 440, facing each other in the third direction (T direction).

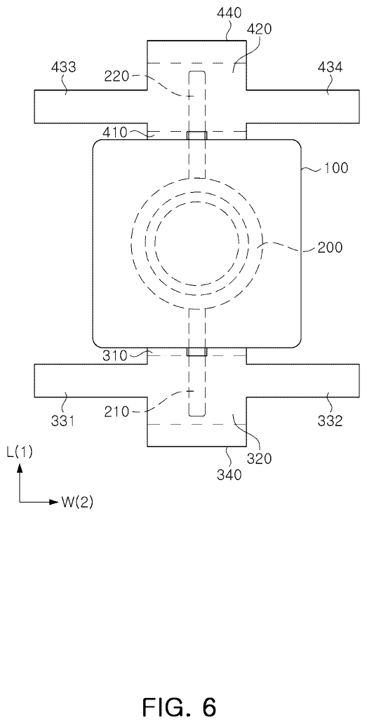

FIG. 6 is a diagram illustrating a state before bending external electrodes 300 and 400.

Referring to FIGS. 2 and 6, after a body 100 including a coil 200 is formed, while the lead-out portions 210 and 220 are respectively coupled to external electrodes 300 and 400, the external electrodes 300 and 400 may be bent in a third direction (T direction) to dispose base portions 320 and 420, and then bent again in a first direction (L-direction) to dispose pad portions 340 and 440, and extension portions 330 and 430 extending from the base portions 320 and 430 may be bent in the first direction (L-direction) to be fixed to a surface of the body 100.

Accordingly, as the external electrodes 300 and 400 of the present embodiment are in contact with the lead-out portions 210 and 220 over a wide area, and include each region, which is bent and wraps around the body 100, the bonding force between the body 100 and the coil 200 may be strengthened, and stress applied in the three-axis (L-axis, W-axis, T-axis) directions may be relieved.

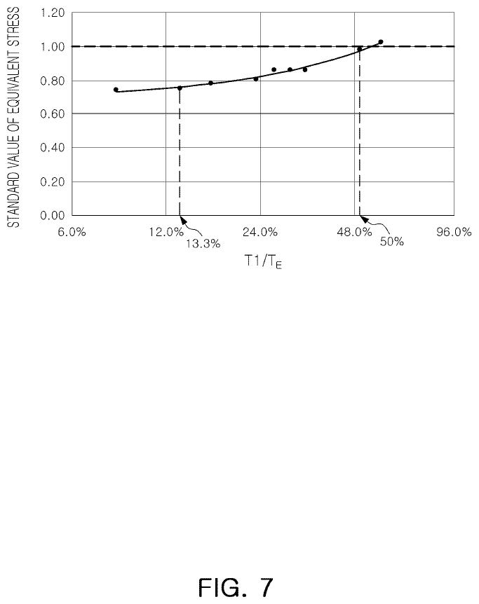

FIG. 7 is a graph illustrating a standard value of equivalent stress according to a change in a minimum distance (T1) between an uppermost extension line of the insertion portions 310 and 410 and an uppermost end of the extension portions 330 and 440. Here, the standard value of equivalent stress means a ratio of equivalent stress applied to the coil component 1000 according to the present embodiment to equivalent stress acting on the coil component including the external electrodes s 300 and 400 without the extension portions 330 and 430.

Referring to FIGS. 4, 5, and 7, a ratio (T1/T_{E}) of a minimum distance (T1) between an uppermost extension line of the insertion portions 310 and 410 and an uppermost end of the extension portions 330 and 440 to a maximum length (T_{E}) of the external electrodes 300 and 400 in the third direction (T direction) may be 13.3% or more and 50% or less.

Here, based on a side image as illustrated in FIG. 4, the maximum length (T_{E}) of the external electrodes 300 and 400 in the third direction (T-direction) may refer to a maximum value of dimensions of each of a plurality of line segments, which are provided by connecting two outermost boundary lines of the external electrode 300, facing each other in the third direction (T direction), illustrated in the image, for example, an uppermost boundary line of the insertion portion 310 and a lowermost boundary line of the base portion 320, to be parallel to the third direction (T direction) and being spaced apart from each other in the second direction (W-direction). The plurality of line segments, parallel to the third direction (T direction) may be equally spaced from each other in the second direction (W-direction), but the scope of the present disclosure is not limited thereto.

In addition, the minimum distance (T1) between the uppermost extension line of the insertion portions 310 and 410 and the uppermost end of the extension portions 330 and 440 may also be measured in a similar manner. For example, based on the side image as illustrated in FIG. 4, the minimum distance (T1) between the uppermost extension line of the insertion portions 310 and 410 and the uppermost end of the extension portions 330 and 440 may refer to a minimum value of dimensions of each of a plurality of line segments, which are provided by setting an extension line obtained by extending the uppermost boundary line of the insertion portion 310, illustrated in the image above, to be parallel to the second direction (W-direction), connecting the extension line and the uppermost end of the first extension portion 331 or the second extension portion 332 to be parallel to the third direction (T direction), and being spaced apart from each other in the second direction (W-direction). The plurality of line segments, parallel to the third direction (T direction) may be equally spaced from each other in the second direction (W-direction), but the scope of the present disclosure is not limited thereto.

Measurement data of equivalent stress related to the graph of FIG. 7 are as follows.

TABLE 1

| | | | | Standard |
|---|---|---|---|---|
| | | | Equivalent | value of |
| Experimental | T1 | | stress | equivalent |
| example | [mm] | T1/T_{E} | [Mpa] | stress |
| Ref. | 0 | 0 | 13.2 | 1.00 |
| #1 | 0.25 | 8.3% | 9.75 | 0.74 |
| #2 | 0.4 | 13.3% | 9.92 | 0.75 |
| #3 | 0.5 | 16.7% | 10.3 | 0.78 |
| #4 | 0.7 | 23.3% | 10.6 | 0.80 |
| #5 | 0.8 | 26.7% | 11.3 | 0.86 |
| #6 | 0.9 | 30.0% | 11.3 | 0.86 |
| #7 | 1 | 33.3% | 11.3 | 0.86 |
| #8 | 1.5 | 50.0% | 12.9 | 0.98 |
| #9 | 1.75 | 58.3% | 13.5 | 1.02 |

Table 1 above is simulation data measuring equivalent stress applied to a coil component 1000 while changing a ratio (T1/T_{E}) of a minimum distance (T1) between the uppermost extension line of the insertion portions 310 and 410 and the uppermost end of the extension portions 330 and 440, relative to the maximum length (T_{E}) of the external electrodes 300 and 400 in the third direction (T-direction).

Referring to Table 1, FIG. 4 and FIG. 7 above, first, a reference experimental example (Ref.) of Table 1 above refers to a coil component in which external electrodes 300 and 400 not including extension portions 330 and 430 are disposed. Based on the equivalent stress of 13.2 MPa applied thereto under such a structure, the equivalent stress was standardized according to the ratio (T1/T_{E}) of the minimum distance (T1) between the uppermost extension line of the insertion portions 310 and 410 and the uppermost end of the extension portions 330 and 440, relative to the maximum length (T_{E}) of the external electrodes 300 and 400 in the third direction (T direction) and expressed as a standard value of equivalent stress. Here, the length of the extension portions 330 and 430 in the third direction (T direction) was set to 1 mm.

Referring to Table 1 and FIG. 7, it can be seen that as T1/T_{E} increases, the standard value of equivalent stress also increases. In Experimental Example #9, when T1/T_{E} becomes 58.3%, it can be seen that the standard value of equivalent stress is 1.02, which rather exceeds the equivalent stress applied to the reference experimental example (Ref.). In this case, the stress relief effect is lost, so it is preferable that T1/T_{E} be set within a range of 50.0% or less of Experimental Example #8.

Meanwhile, as T1/T_{E} decreases, the standard value of equivalent stress also decreases, but referring to Experimental Examples #1 and #2, when T1/T_{E} is lower than 13.3%, the standard value of equivalent stress has a difference of 0.01, which can be considered a small difference within the range of error. Therefore, the stress relief effect becomes constant starting from Experimental Example #2, where T1/T_{E} is 13.3%, and considering a material Poisson's ratio of the external electrodes 300 and 400 and a margin required for a bending process of the insertion portions 310 and 410, it is preferable that T1/T_{E} be set within a range of 13.3% or more of Experimental Example #2.

Therefore, it is preferable that the ratio (T1/T_{E}) of the minimum distance (T1) between the uppermost extension line of the insertion portions 310 and 410 and the uppermost end of the extension portions 330 and 440, relative to the maximum length (T_{E}) of the external electrodes 300 and 400 in the third direction (T direction) be set to 13.3% or more and 50% or less.

Meanwhile, the external electrodes 300 and 400 of the present embodiment may include a conductive material such as copper (Cu), aluminum (Al), silver (Ag), tin (Sn), gold (Au), nickel (Ni), lead (Pb), titanium (Ti), chromium (Cr), molybdenum (Mo), or an alloy thereof, and may be formed in a multilayer structure, but an embodiment thereof is not limited thereto. In addition, the external electrodes 300 and 400 may be formed by being fixed to a frame through a rolling process, but an embodiment thereof is not limited thereto.

In addition, the coil component 1000 according to the present embodiment may further include an insulating layer (not shown) covering the surface of the body 100.

The insulating layer may be formed by a method such as printing, vapor deposition, spray coating, or film lamination, but an embodiment thereof is not limited thereto.

The insulating layer may include a thermoplastic resin such as polystyrene, vinyl acetate, polyester, polyethylene, polypropylene, polyamide, rubber, or acrylic; a thermosetting resin such as phenol, epoxy, urethane, melamine, or alkyd; a photosensitive resin, parylene, SiOx, or SiNx. The insulating layer may further include an insulating filler, such as an inorganic filler, but an embodiment thereof is not limited thereto.

### Second Embodiment and Modified Example

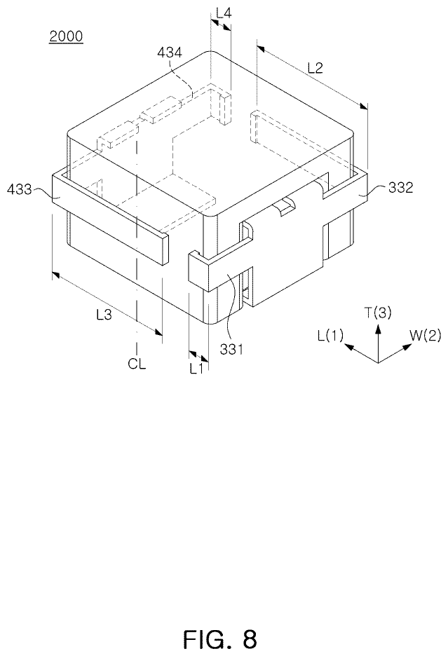

FIG. 8 is a perspective view schematically illustrating a coil component 2000 according to the second embodiment of the present disclosure.

Comparing FIG. 8 with FIG. 1, the coil component 2000 according to the present embodiment has a different shape of extension portions 330 and 440. Therefore, in describing the present embodiment, only the shape of the extension portions 330 and 430, which is different from that of the first embodiment, and a connection relationship between the components will be described, and the description in the first embodiment of the present disclosure may be applied as it is to the remaining components.

Referring to FIG. 8, a length (L1) of the first extension portion 331 in a first direction (L-direction) according to the present embodiment may be different from a length (L2) of the second extension portion 332 in the first direction (L-direction).

In addition, at least one of the first extension portion 331 and the second extension portion 332 may be disposed to pass through a center line (CL) perpendicular to the first direction (L-direction) on the body 100.

Similarly, a length (L3) of the third extension portion 433 in the first direction (L-direction) according to the present embodiment may be different from a length (L4) of the fourth extension portion 434 in the first direction (L-direction).

In addition, at least one of the third extension portion 433 and the fourth extension portion 434 may be disposed to pass through a center line perpendicular to the first direction (L-direction) on the body 100.

As the length of the extension portions 330 and 340 of the coil component 2000 in the first direction (L-direction) increases, so that an area thereof exposed externally increases, so that a heat dissipation effect may be improved. In addition, since symmetry in a diagonal direction may be maintained between the first external electrode 300 and the second external electrode 400, the stress applied to the two surfaces of the body 100, facing each other may be constant.

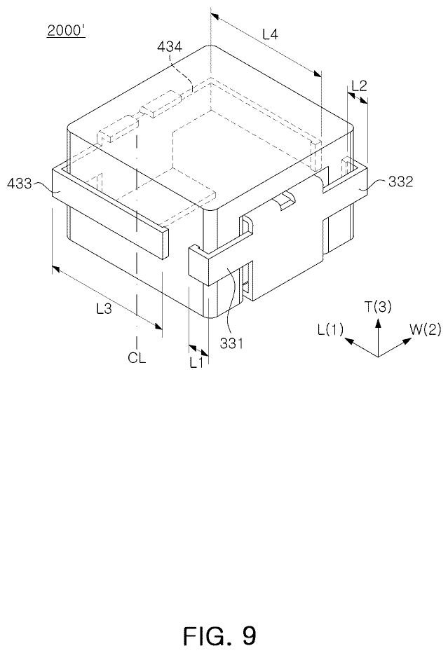

FIG. 9 is a perspective view schematically illustrating a coil component according to a modified example 2000′ of a second embodiment of the present disclosure.

Comparing FIG. 8 with FIG. 9, the coil component 2000′ according to the present modified example has a different shape of extension portions 330 and 430. Therefore, in describing the present embodiment, only the shape of the extension portions 330 and 430, which is different from that of the second embodiment of the present disclosure will be described, and the description in the second embodiment of the present disclosure may be applied as it is to the remaining components.

Referring to FIG. 9, the extension portions 331 and 332 of the first external electrode 300 and the extension portions 433 and 434 of the second external electrode 400 may have different lengths. That is, the length (L1) of the first extension portion 331 in the first direction (L-direction) may be different from the length (L3) of the third extension portion 433 in the first direction (L-direction). In addition, the length (L1) of the second extension portion 332 in the first direction (L-direction) may be different from the length (L4) of the fourth extension portion 434 in the first direction (L-direction). In the case of the present modified example, in addition to the heat dissipation effect and stress relief effect, since the external electrodes 300 and 400 may be distinguished, it can have the effect of making it easy to identify the mounting direction without separate marking.

### Third Embodiment

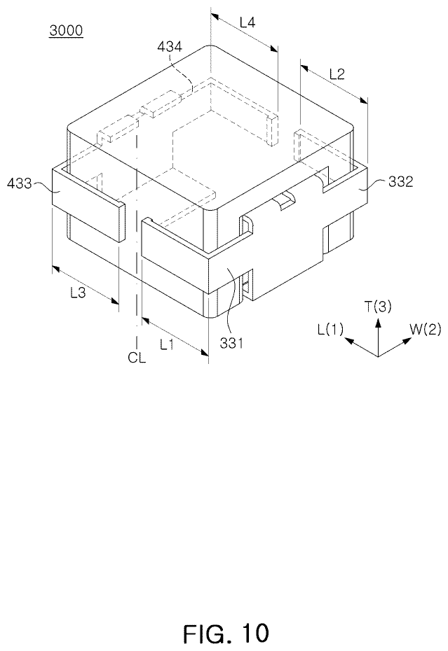

FIG. 10 is a perspective view schematically illustrating a coil component 3000 according to a third embodiment of the present disclosure.

Comparing FIG. 10 with FIG. 1, the coil component 3000 according to the present embodiment has a different shape of extension portions 330 and 430. Therefore, in describing the present embodiment, only the shape of the extension portions 330 and 430, which is different from that of the first embodiment, will be described, and the description in the first embodiment of the present disclosure may be applied as it is to the remaining components.

Referring to FIG. 10, each of the extension portions (331, 332, 433, and 434 of the present embodiment may be implemented to have a longer length in a first direction (L-direction) than each extension portion of the first embodiment.

Meanwhile, each of the first extension portion 331 and the second extension portion 332 may be disposed to be spaced apart from a center line (CL), perpendicular to the first direction (L-direction) on the first surface 101. Similarly, each of the third extension portion 433 and the fourth extension portion 434 may be disposed to be spaced apart from a center line, perpendicular to the first direction (L-direction) on the second surface 102.

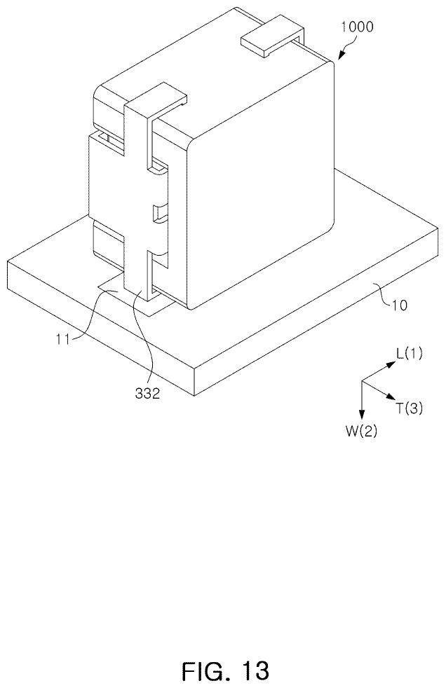

The coil component 3000 of the present embodiment may have a higher stress relief effect as a length of the extension portions 330 and 440 increases, and a heat dissipation effect through the external electrodes 300 and 400 may be improved as a total area of the extension portions 330 and 440 increases. In addition, since each of ends of the extension portions 331, 332, 433, and 434 is symmetrically disposed not to pass through the center line (CL), not only horizontal mounting through the pad portions 340 and 440 as in FIG. 12, may be performed, but also vertical mounting through the extension portions 330 and 430 as in FIG. 13, may be performed.

### Fourth Embodiment

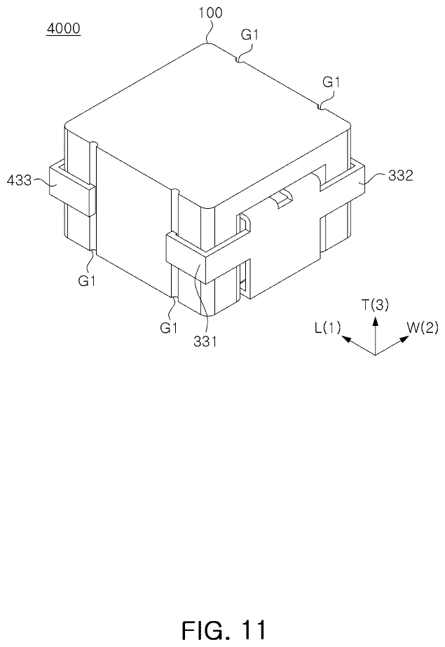

FIG. 11 is a perspective view schematically illustrating a coil component 4000 according to a fourth embodiment of the present disclosure.

Comparing FIG. 11 with FIG. 1, the coil component 4000 according to the present embodiment is different in that it includes a first groove G1 formed in the body 100. Therefore, in describing the present embodiment, only a groove G1, which is different from that of the first embodiment, will be described, and the description in the first embodiment of the present disclosure may be applied as it is to the remaining components.

Referring to FIG. 11, a first groove G1 may be formed on at least one of the third surface 103 and the fourth surface 104 of the body 100, and each of ends of the extension portions 331, 332, 433, and 434 may be fixed to the first groove G1. In addition, the first groove G1 may be disposed parallel to the third direction (T direction).

The first groove G1 may be provided in plural, and it is preferable that the plurality of grooves G1 are formed in the same number as the number of extension portions (331, 332; 433, 434). For example, a total of four first grooves G1 may be included, two on each of the third surface 103 and the fourth surface 104, but the present disclosure is not limited thereto.

According to the present embodiment, the coil component 4000 may strengthen the bonding force between the body 100 and the external electrodes 300 and 400 by having the ends of the extension portions 331, 332, 433, and 434 settled on the first groove G1 formed in the body 100, and the vibration resistance of the coil component 4000 may be improved.

### Fifth Embodiment

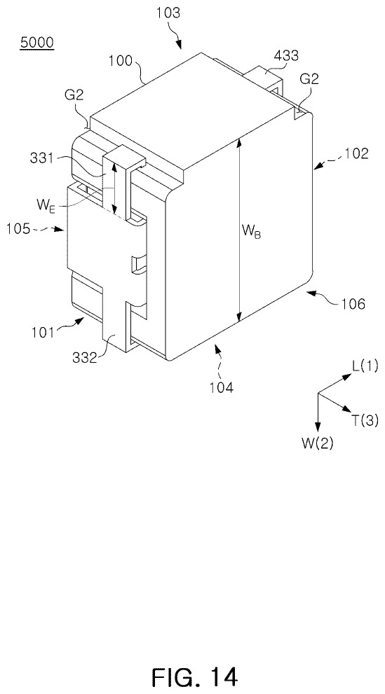

FIG. 12 is a diagram illustrating a form in which the coil component 1000 of FIG. 1 is mounted on a circuit board 10 through pad portions 340 and 440. FIG. 13 is a diagram illustrating a form in which the coil component 1000 of FIG. 1 is mounted on a circuit board through extension portions 332 and 433. FIG. 14 is a perspective view schematically illustrating a coil component 5000 according to a fifth embodiment of the present disclosure.

When mounting a coil component 1000 on a circuit board 10, it is generally mounted horizontally, as illustrated in FIG. 12, and pad portions 340 and 440 of the coil component 1000 are connected to a connection portion 11 of the circuit board 10. However, when a mounting area thereof is limited, extension portions 332 and 433 of the coil component 1000 may be connected to the connection portion 11 of the circuit board 10 by vertical mounting as shown in FIG. 13.

The coil component 5000 according to the fifth embodiment of the present disclosure corresponds to an embodiment, suitable for vertical mounting as shown in FIG. 13.

Comparing FIG. 14 with FIG. 1, the coil component 5000 according to the present embodiment is different in that it includes a second groove G2 formed in the body 100. Therefore, in describing the present embodiment, only the shape of the second groove G2, which is different from that of the first embodiment, and the description in the first embodiment of the present disclosure may be applied as it is to the remaining components.

Referring to FIG. 14, a second groove G2 may be formed in at least one of a region between the first surface 101 and the third surface 103 of the body 100 and a region between the second surface 102 and the third surface 103, and ends of the extension portions 331 and 433 may be fixed to the second groove G2.

A second groove G2 may be provided in plural, and it is preferable that the plurality of second grooves G2 be formed in the number, equal to the number of extension portions 331 and 433, which are not mounted on the circuit board among the extension portions 331, 332, 433, and 434. For example, as in the present embodiment, two second grooves G2 may be formed in the body 100, and each of the end of the first extension portion 331 and the end of the third extension portion 433 may be fixed to the second grooves G2.

### Sixth Embodiment and Seventh Embodiment

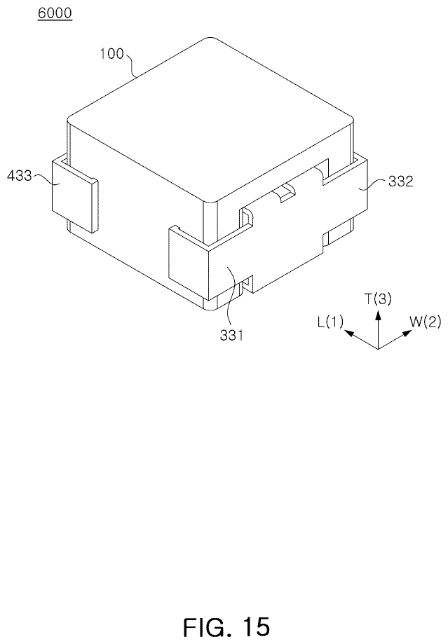

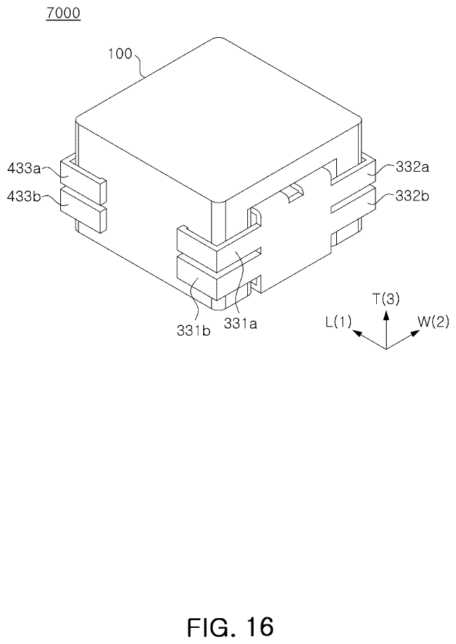

FIG. 15 is a perspective view schematically illustrating a coil component 6000 according to a sixth embodiment of the present disclosure. FIG. 16 is a perspective view schematically illustrating a coil component 7000 according to a seventh embodiment of the present disclosure.

Comparing FIG. 15 and FIG. 16 with FIG. 1, respectively, shapes of extension portions 330 and 430 in the present embodiments s are different. Therefore, in describing the present embodiment, only the shapes of the extension portions 330 and 430, which are different from those of the first embodiment of the present disclosure will be described, and the description in the first embodiment of the present disclosure may be applied as it is to the remaining components.

Referring to FIG. 15, the coil component 6000 according to the sixth embodiment of the present disclosure may be formed so that a size of extension portions 331, 332, 433, and 434 in a third direction (T direction) is greater than that of the extension portions 331, 332, 433, and 434 of the first embodiment.

In the present embodiment, as the size of extension portions 331, 332, 433, and 434 in the third direction (T direction) increases, bonding force between the body 100 and the external electrodes 300 and 400 may be further strengthened, and vibration resistance may be further improved when the coil component 6000 is mounted on a circuit board.

Referring to FIG. 16, the coil component 7000 according to the seventh embodiment of the present disclosure may have at least one of the first extension portion 331, the second extension portion 332, the third extension portion 433, and the fourth extension portion 434, branched into two regions. For example, the first extension portion 331 may be branched into two regions 331a and 331b, and the second extension portion 332 may be branched into two regions 332a and 332b. In addition, the third extension portion 433 may be branched into two regions 433a and 433b, and the fourth extension portion 434 may be branched into two regions 434a and 434b.

When the extension portions 331, 332, 433, and 434 of the present embodiment are branched into two regions, even if one region is damaged, the bonding force between the body 100 and the external electrode 300 and 400 may be maintained in the remaining region, and since an elastic force is partially applied by a gap between the two regions, the vibration resistance against up-and-down vibration may be improved.

According to an embodiment of the present disclosure, in a coil component, an external electrode includes an extension portion, so that bonding force between a body and an external electrode may be strengthened, so that vibration resistance may be improved, when the coil component is mounted on a circuit board.

According to an embodiment of the present disclosure, the coil component may have improved heat dissipation properties by increasing an exposed area of the external electrode.

While example embodiments have been illustrated and described above, it will be apparent to those skilled in the art that modified examples and variations could be made without departing from the scope of the present disclosure as defined by the appended claims.

What is claimed is:

1. A coil component, comprising:
a body including a first surface and a second surface, facing each other in a first direction, and a third surface and a fourth surface, facing each other in a second direction perpendicular to the first direction;
a coil disposed in the body; and
an external electrode disposed in the body and connected to the coil,
wherein the external electrode includes a base portion disposed on the first surface or the second surface, an insertion portion bent from the base portion wherein at least a portion of the insertion portion is disposed in the body, and an extension portion bent from the base portion and respectively extending to the third surface and the fourth surface.

2. The coil component of claim 1, wherein the body further includes a fifth surface and a sixth surface, facing each other in a third direction perpendicular to the first direction and the second direction, respectively, and
the external electrode further includes a pad portion extending from the base portion to the fifth surface.

3. The coil component of claim 2, wherein the base portion, the insertion portion, the extension portion, and the pad portion are formed integrally.

4. The coil component of claim 2, wherein the external electrode is spaced apart from the sixth surface.

5. The coil component of claim 2, wherein a ratio (T1/T_{E}) of a minimum distance (T1) between an uppermost extension line of the insertion portion and an uppermost end of the extension portion, relative to a maximum length (T_{E}) of the external electrode in the third direction is 13.3% or more and 50% or less.

6. The coil component of claim 1, wherein the extension portion includes a first extension portion wherein at least a portion of the first extension portion extends to the third surface, and a second extension portion wherein at least a portion of the second extension portion extends to the fourth surface, and
a length of the first extension portion in the first direction is different from a length of the second extension portion in the first direction.

7. The coil component of claim 6, wherein at least one of the first extension portion and the second extension portion passes through a centerline, perpendicular to the first direction on the body.

8. The coil component of claim 6, wherein each of the first extension portion and the second extension portion is spaced apart from a center line perpendicular to the first direction on the body.

9. The coil component of claim 1, wherein the external electrode includes a first external electrode disposed on the first surface, and a second external electrode disposed on the second surface,
the first external electrode includes a first extension portion wherein at least a portion of the first extension portion extends to the third surface, and a second extension portion wherein at least a portion of the second extension portion extends to the fourth surface, and
the second external electrode includes a third extension portion wherein at least a portion of the third extension portion extends to the third surface, and a fourth extension portion wherein at least a portion of the fourth extension portion extends to the fourth surface.

10. The coil component of claim 9, wherein a length of the first extension portion in the first direction is different from a length of the third extension portion in the first direction.

11. The coil component of claim 9, wherein at least one of the first extension portion, the second extension portion, the third extension portion, and the fourth extension portion is branched into two regions.

12. The coil component of claim 2, wherein a first groove is formed on at least one of the third surface and the fourth surface, and
an end of the extension portion is fixed to the first groove.

13. The coil component of claim 12, wherein the first groove is disposed parallel to the third direction.

14. The coil component of claim 2, wherein a second groove is formed in at least one of a first region between the first surface and the third surface and a second region between the second surface and the third surface, and
an end of the extension portion is fixed to the second groove.

15. The coil component of claim 14, wherein the second groove is disposed parallel to the third direction.

16. The coil component of claim 1, wherein at least a portion of an end of the insertion portion includes an opening.

17. The coil component of claim 1, wherein the coil includes a lead-out portion drawn out onto the body, and
the lead-out portion is disposed between the body and the external electrode.

18. The coil component of claim 2, wherein a recess is formed in at least one of a first region between the first surface and the fifth surface and a second region between the second surface and the fifth surface, and
the base portion and the pad portion are disposed on the recess.

19. A coil component, comprising:
a body including a first surface and a second surface, facing each other in a first direction, a third surface and a fourth surface, facing each other in a second direction, and a fifth surface and a sixth surface, facing each other in a third direction;
a coil disposed in the body; and
a first external electrode and a second external electrode disposed in the body, connected to the coil, and facing each other in the first direction,
wherein each of the first external electrode and second external electrode includes an insertion portion wherein at least a portion of the insertion portion is disposed in the body, an extension portion extending to both sides thereof in the second direction and respectively being bent in the first direction, and a pad portion extending to the fifth surface, and
respective ends of the extension portion each of the first external electrode and second external electrode face each other in the second direction, and the insertion portion and the pad portion face each other in the third direction.
